(19) United States
(12) Patent Application Publication
(10) Pub. No.: US 2017/0178085 A1
(43) Pub. Date: Jun. 22, 2017

(54) METHOD, APPARATUS, AND SYSTEM FOR MANAGING RESERVATIONS

(71) Applicant: GTS Holdings, Inc., Secaucus, NJ (US)

(72) Inventors: Jon Kragh, Secaucus, NJ (US); David Seelinger, Secaucus, NJ (US)

(21) Appl. No.: 14/978,648

(22) Filed: Dec. 22, 2015

(51) Int. Cl. G06Q 10/10; G06Q 10/06

(52) U.S. Cl. CPC G06Q 10/1097; G06Q 10/063114

(57) ABSTRACT

The technology relates to determining a driver for a trip having a start time within a predetermined time period. A trip itinerary and a list of available drivers for a first client's trip may be received by one or more processors. The list of available drivers may each include a respective driver status indicating each trip scheduled for the driver for the predetermined time period. The one or more processors may remove one or more drivers from the list of available drivers to obtain a reduced list of available drivers based on the respective driver status of each available driver. A driver from the reduced list of available drivers may be selected by the one or more processors based on the reduced list of available drivers and the trip itinerary for the first client's trip.

### BACKGROUND

Transportation services may provide thousands of trips to customers a day. As the number of trips requested by the customers increase, the complexity in scheduling drivers to perform these trips becomes exponentially more difficult. In this regard, while brute force methods of scheduling may be able to create the necessary schedules, they may fail to take into account operatives such as operating efficiency and consumer happiness.

Accordingly, there is a need for systems, apparatuses, and methods which provide transportation companies with the ability to create schedules which maintain key operatives such as consumer and driver happiness, while maintaining operating efficiency.

### SUMMARY

Embodiments within the disclosure relate generally to a distributed reservation system. One aspect includes a computer implemented method for determining a driver for a trip having a start time within a predetermined time period. A trip itinerary and a list of available drivers for a first client's trip may be received by one or more processors. The list of available drivers may each include a respective driver status indicating each trip scheduled for the driver for the predetermined time period. The one or more processors may remove one or more drivers from the list of available drivers to obtain a reduced list of available drivers based on the respective driver status of each available driver. A driver from the reduced list of available drivers may be selected by the one or more processors based on the reduced list of available drivers and the trip itinerary for the first client's trip.

In some versions of the present technology the trip itinerary may include a pick-up location, a drop off location, and a time for the trip.

In some versions of the present technology one or more respective driver statuses may include at least one of an estimated shift length, a predicted driver status, a minimum travel duration for a scheduled trip, a vehicle type, a client approval, a license type, or a ranking.

In some versions of the present technology removing one or more drivers from the list of available drivers may further include removing a given driver whose driver status includes at least one of: an estimated shift length greater than a predetermined threshold or a predicted driver status indicated as unavailable.

In some versions of the present technology the trip itinerary may further include a client preferred vehicle type and a client excluded driver name, and removing one or more drivers from the list of available drivers may further include removing a given driver whose driver status includes at least one of: a minimum travel duration greater than a predetermined threshold; a vehicle type other than the client preferred vehicle type; or a name matching the client excluded driver name.

In some versions of the present technology removing one or more drivers from the list of available drivers may include determining at least one of: an expected travel distance for a given driver to a pick-up location for the trip; an expected travel duration for the trip; an expected time gap between the trip and a second trip scheduled for the given driver immediately before or after the trip; or an estimated shift length of the given driver.

In some versions of the present technology the expected travel duration may be determined using a multiplier obtained from expected traffic data.

In some versions of the present technology the expected travel duration may be determined using real time traffic data.

Another aspect of the present technology may include a system for determining a driver for a trip having a start time within a predetermined time period. The system may include a one or more computing devices and memory storing instructions which are executable by the one or more computing devices. The instructions may include receiving a trip itinerary for a first client's trip; receiving a list of available drivers, wherein each available driver on the list of available drivers includes a respective driver status indicating each trip scheduled for the driver for the predetermined time period; removing, based on the respective driver status of each available driver, one or more drivers from the list of available drivers to obtain a reduced list of available drivers; and selecting, based on the reduced list of available drivers and the trip itinerary for the first client's trip, a driver from the reduced list of available drivers.

A further aspect of the present technology may include a non-transitory computer-readable medium storing instructions that when executed determine a driver for a trip having a start time within a predetermined time period. The instructions may cause the one or more processors to perform the steps of receiving a trip itinerary for a first client's trip; receiving a list of available drivers, wherein each available driver on the list of available drivers includes a respective driver status indicating each trip scheduled for the driver for the predetermined time period; removing, based on the respective driver status of each available driver, one or more drivers from the list of available drivers to obtain a reduced list of available drivers; and selecting, based on the reduced list of available drivers and the trip itinerary for the first client's trip, a driver from the reduced list of available drivers.

Another aspect of the present technology may include a computer implemented method for allocating drivers to a plurality of trips for a plurality of clients, each of the trips having a start time within a same predetermined time period. One or more processors may receive, for one or more of the plurality of clients, driver requests, the driver requests including an indication of the client's requested driver for one of the plurality of trips; receive one or more client preferences for one or more of a plurality of clients. The one or more processors may store a client status for each of the plurality of clients in association with the one or more client preferences for each of the plurality of clients and allocating a driver to each of the plurality of trips based upon the one or more driver requests, the one or more client preferences, and the client status for each of the plurality of clients.

In some versions of the present technology allocating drivers to a plurality of trips for a plurality of clients may further include receiving, for each driver, a start time and end time, wherein the start time indicates the beginning of a shift and the end time indicates the ending of a shift; and wherein the allocating is further based upon at least one of the start time or the end time of each driver.

In some versions of the present technology each of the driver requests may include an indication of at least one backup requested driver for the one of the plurality of trips.

In some versions of the present technology allocating a driver to each of the plurality of trips may further comprise: ranking each of the plurality of clients according to their respective client status from a high ranking to a low ranking and allocating the client's requested driver to the highest ranking client not yet assigned a driver; and repeating the allocating of the client's requested drivers for each of the plurality of clients not yet assigned a driver.

In some versions of the present technology the one or more client preferences for one or more of a plurality of clients may include a client preferred driver.

In some versions of the present technology allocating drivers to a plurality of trips for a plurality of clients may further comprise allocating the client's preferred driver to the highest ranking client not yet assigned a driver; and repeating the allocating of the client's preferred drivers for each of the plurality of clients not yet assigned a driver.

In some versions of the present technology allocating a driver to each of the plurality of trips may further comprise, after allocating the client's requested and preferred drivers, allocating drivers, by the start and end time of each driver.

Another aspect of the present technology may include a system for allocating drivers to a plurality of trips for a plurality of clients, each of the trips having a start time within a same predetermined time period. The system may include a one or more computing devices and memory storing instructions which are executable by the one or more computing devices. The instructions may include receiving for one or more of the plurality of clients, driver requests, the driver requests including an indication of the client's requested driver for one of the plurality of trips; receiving one or more client preferences for one or more of a plurality of clients; storing a client status for each of the plurality of clients in association with the one or more client preferences for each of the plurality of clients; and allocating a driver to each of the plurality of trips based upon the one or more driver requests, the one or more client preferences, and the client status for each of the plurality of clients.

A further aspect of the present technology may include a non-transitory computer-readable medium storing instructions that when executed allocate drivers to a plurality of trips for a plurality of clients, each of the trips having a start time within a same predetermined time period. The instructions may cause the one or more processors to perform the steps of receiving for one or more of the plurality of clients, driver requests, the driver requests including an indication of the client's requested driver for one of the plurality of trips; receiving one or more client preferences for one or more of a plurality of clients; storing a client status for each of the plurality of clients in association with the one or more client preferences for each of the plurality of clients; and allocating a driver to each of the plurality of trips based upon the one or more driver requests, the one or more client preferences, and the client status for each of the plurality of clients.

One aspect of the technology may include a computer implemented method for predicting an estimated time of arrival for a trip. One or more processors may receive trip information, wherein the trip information includes an indication whether the trip is determinate or indeterminate, and an indication whether the trip is in progress. The one or more processors may determine, based on the trip information and the indication whether the trip is in progress, an estimated time of arrival for the trip.

In some versions of the present technology the determinate trip may include one or more stops at a predetermined locations and the indeterminate trip includes an unknown number of stops at an unknown number of locations.

In some versions of the present technology determining an estimated time of arrival for the trip may further include: receiving an indication that the trip is in progress; and determining a real-time estimate of the time of arrival.

In some versions of the present technology determining a real-time estimate of the time of arrival may further include: receiving a location signal, wherein the signal indicates latitude and longitude of the vehicle performing the trip; calculating a travel duration based on the location signal; and updating the estimated time of arrival for the trip based on the calculated travel duration.

In some versions of the present technology the trip information may further include a pickup time, pickup location, and drop off location, and determining an estimated time of arrival for the trip may further include: receiving an indication that the trip is not in progress; receiving an indication the current time is before the pickup time; calculating an estimated time of travel, wherein the estimated time of travel is based on the pickup location and drop off location; and determining, based on the pickup time and the estimated time of travel, the estimated time of arrival for the trip.

In some versions of the present technology wherein the trip information may further includes a pickup time, pickup location, and drop off location, and determining an estimated time of arrival for the trip may further include: receiving an indication that the trip is not in progress; receiving an indication that the current time is after the pickup time; calculating an estimated time of pickup, wherein the estimated time of pickup is based on the pickup location and a current location of a vehicle to which the trip is assigned; calculating an estimated time of travel, wherein the estimated time of travel is based on the pickup location and drop off location; and determining the estimated time of arrival for the trip based on the estimated time of pickup and the estimated time of travel.

Another aspect of the present technology may include a system for predicting an estimated time of arrival for a trip. The system may include a one or more computing devices and memory storing instructions which are executable by the one or more computing devices. The instructions may include receiving trip information, wherein the trip information includes an indication whether the trip is determinate or indeterminate; receiving an indication whether the trip is in progress; and determining based on the trip information and the indication whether the trip is in progress, an estimated time of arrival for the trip.

A further aspect of the present technology may include a non-transitory computer-readable medium storing instructions that when executed predict an estimated time of arrival for a trip. The instructions may cause the one or more processors to perform the steps of receiving trip information, wherein the trip information includes an indication whether the trip is determinate or indeterminate; receiving an indication whether the trip is in progress; and determining based on the trip information and the indication whether the trip is in progress, an estimated time of arrival for the trip.

### BRIEF DESCRIPTION OF THE DRAWINGS

The foregoing aspects, features and advantages of the present invention will be further appreciated when considered with reference to the following description of exemplary embodiments and accompanying drawings, wherein like reference numerals represent like elements. In describing the exemplary embodiments of the invention illustrated in the drawings, specific terminology may be used for the sake of clarity. However, the aspects of the invention are not intended to be limited to the specific terms used.

FIG. 1 is a functional diagram of an example system in accordance with aspects of the disclosure.

FIG. 2 is a pictorial diagram of the example system of FIG. 1.

FIG. 3 is a block diagram of allocating drivers to specific trips in accordance with aspects of the disclosure.

FIG. 4 is a flow diagram of specific driver allocation in accordance with aspects of the disclosure.

FIG. 5 is a flow diagram of optimized driver allocation in accordance with embodiments of the disclosure.

FIG. 6 is a flow diagram of predictive estimated time of arrival in accordance with aspects of the disclosure.

FIG. 7 is a flow diagram of real-time estimated time of arrival in accordance with aspects of the disclosure.

FIG. 8 is a flow diagram of estimated travel duration in accordance with aspects of the disclosure.

FIG. 9 is a flow diagram of a predictive status algorithm in accordance with aspects of the disclosure.

### DETAILED DESCRIPTION

### Overview

This technology relates to, by way of example, providing the ability to allocate drivers for current and future trip reservations (“trips”). In this regard, a transportation company, such as a taxicab or chauffeuring company, may iterate through models to determine which driver, from a pool of drivers, is best suited to be assigned a particular trip.

The features described herein may also allow for transportation companies to meet certain operating goals. Such operating goals may include minimizing inefficiencies in providing transportation services (e.g., reducing long gap times between pick-ups, avoiding circuitous routes to the next pick-up, etc.), increasing customer satisfaction, increasing driver happiness, etc. In many ways the operating goals of the transportation company may be intertwined. For example, minimizing inefficiencies will likely increase work for drivers (i.e., increase driver happiness) and assure timely transportation for customers (i.e., increase customer happiness). However, at other times the goals may be in conflict, such as, for example, when the next few trips are located far away from a driver who has not been assigned a trip for a long period of time. As such, the transportation company may adjust the models based on the goals which they deem more important-customer satisfaction and transportation efficiency (i.e., assigning a closer driver), or driver happiness (i.e., assigning the driver who has not been assigned a trip for more than a certain period of time regardless of distance to the pick-up).

Although the technology is described in association with ground transportation services, including cars, vans, limousines, trucks, vans, etc., the technology may also be used in autonomous vehicle systems and aerial transportation services, such as helicopters, airplanes, drones, etc.

### Example Systems

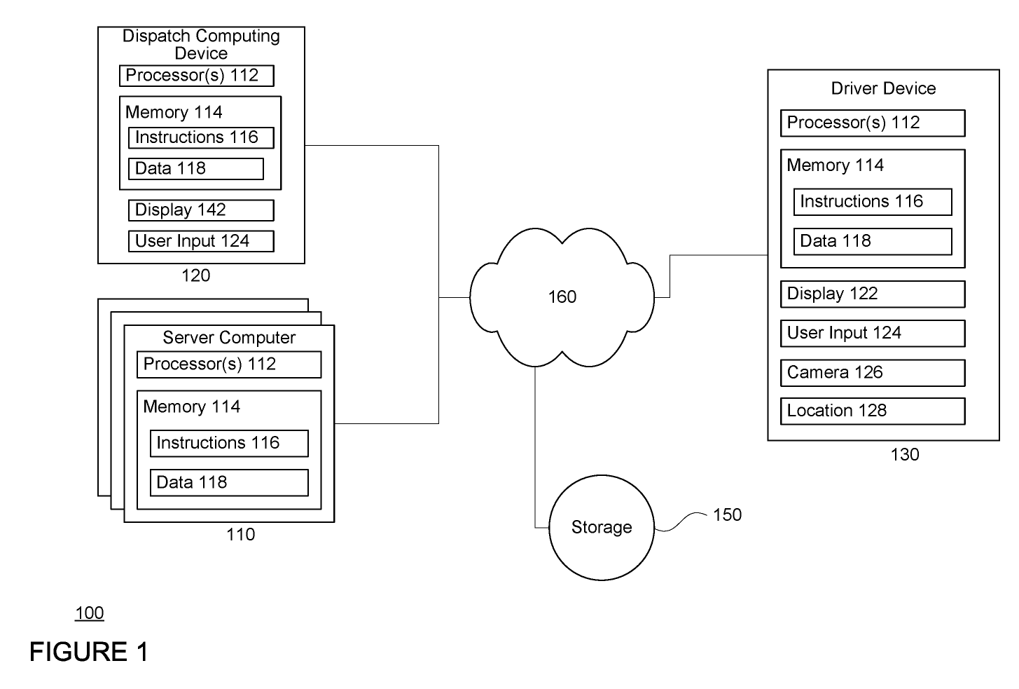

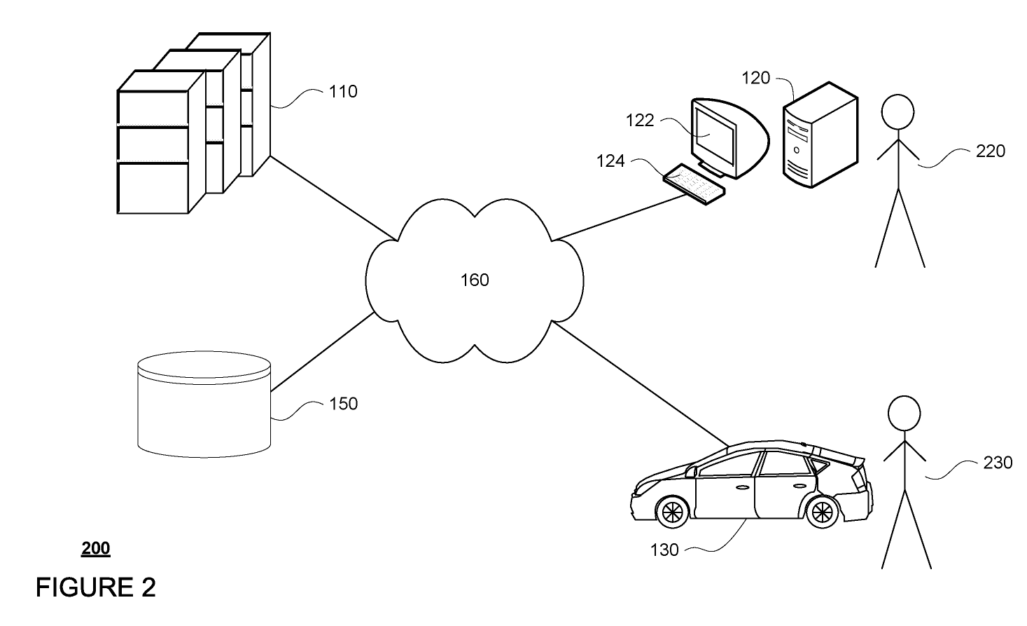

FIGS. 1 and 2 include an example system 100 in which the features described herein may be implemented. It should not be considered as limiting the scope of the disclosure or usefulness of the features described herein. In this example, system 100 may include computing devices 110-130, which include server computers 110, dispatch computing device 120, and driver device 130, as well as storage system 150. Each computing device 110-130 can contain one or more processors 112, one or more memory 114, and other components commonly found in general and special purpose computing devices.

Memory 114 of each of computing devices 110, 120, and 130 can store information accessible by the one or more processors 112, including instructions 116 that can be executed by the one or more processors 112. Memory can also include data 118 that can be stored, manipulated, or retrieved by the processor. Such data 118 can also be used for executing the instructions 116 and/or for performing other functions. The memory can be of any non-transitory type capable of storing information accessible by the processor, such as a hard-drive, solid state hard-drive, memory card, ROM, RAM, DVD, CD-ROM, write-capable, read-only memories, and other such non-transitory types of memory.

The instructions 116 can be any set of instructions capable of being read and executed directly or indirectly by the one or more processors. In some embodiments the instructions may be stored in a location separate from the computing device, such as in a remote network storage drive, such as storage system 150. The operations which the instructions cause the one or more processors to execute are explained in more detail below. The terms “instructions,” “functions,” “application,” “steps,” and “programs” can be used interchangeably herein.

Data 118 can be created, edited, stored, read, and executed by the one or more processors 112 in accordance with the instructions 116. Although the technology described herein is not limited by any particular data structure, the data can be stored in one or more of computer registers, relational databases, SQL or MySQL databases, Document Databases, as tables having many different fields and records, XLS documents, TXT documents, or XML documents. The data can also be formatted in any computing device-readable format such as, but not limited to, binary values, ASCII or Unicode. Moreover, the data can comprise any information sufficient to identify other relevant information, such as numbers, descriptive text, proprietary codes, pointers, references to data stored in other memories such as at other network locations, or information that is used by a function to calculate the other relevant information.

The one or more processors 112 can be any processors, such as commercially available CPUs from Intel, AMD, or Apple. Alternatively, the processors can be dedicated components such as an application specific integrated circuit (“ASIC”) or other hardware-based processors, such as ARM processors or System on Chips (SoCs). Alternatively, the processors can be dedicated components such as an application specific integrated circuit (“ASIC”) or other hardware-based processor. One or more of computing devices 110, 120, and 130 may include specialized hardware components, such as GPUs from AMD, NVIDIA, or Intel, to perform specific computing processes, such as decoding video, matching video frames with images, distorting videos, encoding distorted videos, etc. faster or more efficiently.

Although FIG. 1 functionally illustrates the components of the computing device 110 (i.e., processor, memory, etc.,) as being single components, the components may actually comprise multiple processors, computers, computing devices, or memories that may or may not be contained within the same physical housing. For example, the memory 114 can be a hard drive or other storage media located in a housing(s) different from that of the other components of computing device 110. The same may be true of the components within the other computing devices 120 and 130. Accordingly, references to a processor, computer, computing device, or memory will be understood to include references to a collection of processors, computers, computing devices, or memories that may or may not operate in parallel. Further, although some functions described below are indicated as taking place on a single computing device having a single processor, various aspects of the subject matter described herein can be implemented by a plurality of computing devices in series or in parallel.

Storage device 150 can be of any type of storage capable of storing information accessible by the server computing devices 110, member computing device 120, or retail computing device 140, such as a hard-drive, a solid state hard drive, NAND memory, ROM, RAM, DVD, CD-ROM, write-capable, and read-only memories. In addition, storage device 150 may include a distributed storage device where data is stored on a plurality of different storage devices which may be physically located at the same or different geographic locations, such as network attached storage. Storage device 150 may be connected to the computing devices via the network 160 as shown in FIG. 1, and/or may be directly connected to any of the computing devices 110, 120, and 130.

The network 160 and intervening nodes, described herein, can be interconnected using various protocols and systems. For example, the network 160 may be implemented via the Internet, intranets, local area networks (LAN), wide area networks (WAN), etc. Communication protocols such as Ethernet, WiFi, and HTTP, Bluetooth, LTE, 3G, 4G, Edge, etc., and various combinations of the foregoing may be used to allow the nodes to communicate.

Each of the computing devices 110, 120, and 130 can be implemented by directly and/or indirectly communicating over the network 160. In this regard, each of the computing devices 110, 120, and 130, as well as storage device 150, can be at different nodes of a network 160 and capable of directly and indirectly communicating with other nodes of network 160. As an example, each of the computing devices 110-130 may include web servers capable of communicating with storage system 150 via the network. For example, one or more of server computing devices 110 may use network 160 to transmit and present information to a user, such as dispatcher 220 or driver 230, on a display, such as displays 122 of computing devices 120 and 130, respectively.

Although only a few computing devices are depicted in FIGS. 1-2, a system can include a large number of connected computing devices 110, 120, and 130. Each different computing device can be at a different node of the network 160. For example, each driver, of which there may be an indefinite number, may have at least one client computing device 130. Similarly, each dispatcher may typically have at least one dispatch computing device 120. As a further example, each of the computing devices 110 may include web servers, operating at different nodes on the network 160, capable of communicating with storage system 150 as well as with computing devices 120 and 130 via the network. For example, one or more of server computing devices 110 may use network 160 to transmit and present information to a user, such as dispatcher 220 or driver 230, on a display, such as displays 122 of computing devices 120 or 130.

Each of the computing devices 120 and 130 may be configured similarly to the server computing devices 110, with one or more processors, memory and instructions as described above. Computing devices 120 and 130 may be a personal computing device intended for use by a user 220 and 230, and have all of the components normally used in connection with a personal computing device such as a central processing unit (CPU), memory (e.g., RAM and internal hard drives) storing data and instructions, a display such as displays 122, (e.g., a monitor having a screen, a touch-screen, a projector, a television, or other device that is operable to display information), and user input device 124 (e.g., a mouse, keyboard, touch-screen, or microphone). Although not shown, server computing devices 110 may also include displays and user input devices. The computing devices 110-130 may also include a camera 126 for recording video streams and/or capturing images, speakers, a network interface device, and all of the components used for connecting these elements to one another. Although not shown, the driver computing device 130 may be an in-dash computer system including touch-screen, steering wheel, and/or voice command user inputs.

Although the computing devices 120 and 130 may each comprise a full-sized personal computing device, they may alternatively comprise mobile computing devices capable of wirelessly exchanging data with a server over a network such as the Internet. By way of example only, driver computing device 130, although depicted as a vehicle based computing device, may be a mobile phone or a device such as a wireless-enabled PDA, a tablet PC, or a netbook that is capable of obtaining information via the Internet. In another example, client computing device 130 may be a laptop computer.

A transportation company may operate one or more servers which maintain a trip itinerary for each requested trip reservation. In this regard, the servers, such as server computers 110, may maintain one or more storage devices, such as storage device 150, which store the trip itinerary, as well as data generated by the transportation company in a database. Trip requests may be received by the transportation company from customers through a reservation system. The reservation system may be operated by the transportation company, such as on server computers 110, or by a third party. The reservation system may include a call system, a website, a SMS based system, and/or other known means of making and receiving requested trip reservations for transportation services. Customers may input a reservation request through the reservation system. In some embodiments, customers may have an ongoing trip reservation, such as a standing daily, weekly, monthly, etc., trip reservation with the transportation company

Trip itineraries may include all, or some, data common to a trip, such as found in Table 1, below. Each type of data in Table 1 may represent a data field which is stored in association with a trip itinerary.

TABLE 1
Trip Itinerary Information

Customer Information
Geocoded Stop Locations
Predictive/Real time ETA
Current Trip Status
Travel Routes for all Stop
Locations
Estimated Travel Duration
Requested Driver
Customer Preferred Drivers
Trip Type
Pick-up Time
Customer Status
Upgrade Status

The central server may also store driver data. Driver data may include all, or some, data common to drivers who work for, or contract with, the transportation company, such as the data found in Table 2, below. Each type of data in Table 2 may represent a data field which is stored in association with an individual driver.

TABLE 2
Driver Data

Name
Work Schedule
Vehicle Schedule
Ignore Times
Geocoded Home Location
Geocoded Garage Location
Driver Type
License Information
Location
Current Vehicle Code

The server computing device 110 may be configured to provide specific functions in accordance with embodiments of the technology. For example, the server computing device 110 may be programmed to apply driver allocation models and perform other processes as discussed further herein. In this regard the server computing device 110 may automatically perform the processes and/or perform the processes once received new information, such as a new driver or new trip request and/or perform the processes once a user input is received, such as a user input received from a dispatcher 220 requesting a process be performed.

In some embodiments, one or more of the functions of the server computer 110 may be implemented by dispatch computing device 120. As such, the user of the dispatch computing device 120, such as dispatcher 220, may operate servers which perform the functions of the server computer 110 in place of, or in concert with the transportation company's server computing device 110. In this regard, the dispatcher computing device 120 may be programmed with the transportation company's programs to perform some or all of the operations performed by the transportation company's server computing device 110.

The dispatch computing device 120 may also be configured to provide specific functions in accordance with embodiments of the technology. For example, the dispatch computing device 120 may be programmed to allow its user, such as dispatcher 220, to apply driver allocation models and perform other processes as discussed further herein. In this regard the dispatch computing device may directly perform the processes or interact with the server computer to control the driver allocation process.

The dispatch computing device 120 may allow the dispatcher to assign trips to drivers, such as drivers 230. In this regard, dispatch computing device 120 may be able to communicate, via the network 160, with each driver computing device 130 associated with the driver who has been assigned a trip. For example, the dispatch computing device 120 may transmit a trip itinerary to a driver assigned to the trip associated with the trip itinerary. In some embodiments, the dispatcher computing device 120 may be programmed to automatically assign trips to drivers at predetermined periods of time, such as once a month, once a week, daily, every hour, or more or less. Further, the dispatch computing device 120 may receive information from the drivers, such as driver 130, including location information, work schedules, ignore times, and other such information which may be used in the driver allocation process. In some embodiments, the information from the drivers may be sent directly from the drivers to the server computing device 110.

Each trip associated with the trip reservations may be assigned to a driver. The drivers may be employees of the transportation company, a contractor, or other such associate of the transportation company. Each driver may drive his own vehicle or be supplied a vehicle by the transportation company or from elsewhere. In some embodiments each driver may have one or more license types, such as a taxi and limousine commission (TLC) license or a commercial driver license (CDL).

Driver computing device 130 may be configured to provide specific functions in accordance with embodiments of the technology. In this regard, the driver computing device 130 may be configured to provide driver data to the server computing device 110 and/or the dispatch computing device 120. For example, the driver computing device 130 may transmit location data to the server computing device 110 at predetermined intervals, such as every minute. As such the server computing device 110 may be able to track the location of the driver.

The driver computing device 130 may also be configured to receive and transmit information about trips and/or customers. In this regard, the driver computing device 130 may be configured to allow a driver to input confirmation notifications when a customer for a trip has been picked up and/or dropped off. In some embodiments, the driver computer may organize trip information received from the dispatch computer 120 or server computer 110. In this regard, the driver computing device may automatically display information about the current trip or any other trip. Such displayed information may include, for example, customer information, trip itinerary information, route information/directions, etc. Additionally, the driver computer device 130 may be configured to provide real-time video captured by camera 126 to the dispatch computing device 120 to increase driver and customer safety.

### Example Methods

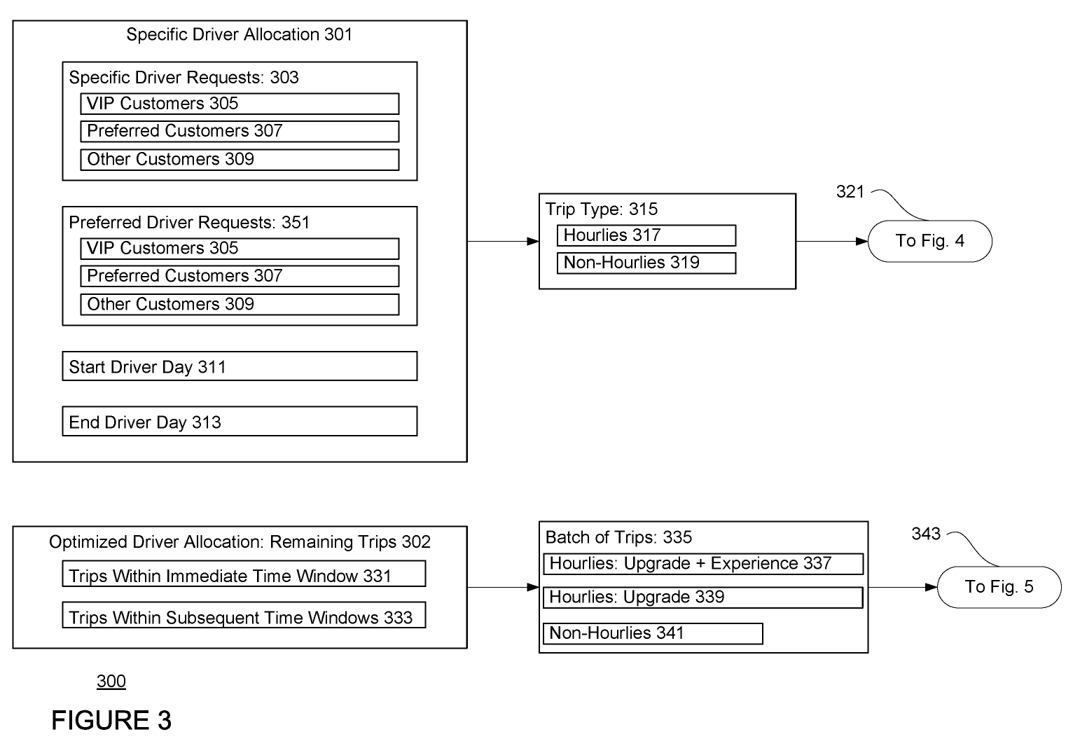

For purposes of illustrating the features of the present technology, exemplary processes for scheduling and assigning trips as shown in FIGS. 3-9, are described below in connection with operations performed at components of the system 100, as described in FIGS. 1 and 2. It is to be understood that the some or all of the operations performed at the dispatch computing device 120 may be performed at the driver computing device 130, and some or all of the operations performed at the dispatch computing device 120 may be performed at the server computer 110, or vice versa. Additionally, some or all of the operations performed at the driver computing device 130 may be performed at the server computer 110, or vice versa.

Referring now to FIG. 3, a high-level block diagram 300 of a driver allocation process performed by the transportation company is shown. The driver allocation process may evaluate trip reservation requests using various permutations to determine, assign, and/or recommend, the best driver for a trip. In this regard, the dynamic driver allocation process may continually perform processing on all of the trips, taking into account new, cancelled, and completed trip reservation requests. For example, upon an initial execution of the driver allocation process, all of the trips, which are capable of being filled, may be assigned to drivers. However, after a period of time a change may have occurred within the plurality of reservations requests, such as a customer cancelling a trip, traffic conditions worsening, a new trip being entered, etc. As such, the driver allocation process, when executed subsequently, may take into account these changes and reallocate all of the drivers to the trips based on the updated reservation requests. In some instances drivers may be allocated to different trips, be left on the same trips, and/or be removed from all trips.

In some embodiments, a driver may be locked into a trip a pre-determined time period before the trip is reached, such as two hours, or more or less before the start of the trip. The reservation request may then be removed from future execution of the process that uses an allocation model. As such, drivers and customers may be provided with the necessary information for completing the trip. For example, the customer may be provided with an email or SMS confirmation which includes the assigned driver's name, car model, license plate number, etc., while the driver may receive information at the driver computing device 130, such the customer's name, address, and personal preferences. It may be possible for certain reservation request to not receive an assigned driver. In those instances, the reservation requests may be cancelled, contracted out, and/or continued to be put through the driver allocation process.

Trip reservation requests may be processed according to the associated trip itinerary, such as the trip itinerary information found in Table 1. For example, reservation requests which include associated trip information, such as a specific driver request or have a preferred driver, may be processed under a specific driver allocation process as shown in block 301. Trips which do not include a specific driver or preferred driver request may be processed under an optimized driver allocation process as shown in block 302. In some embodiments trip reservation requests which include specific driver or preferred driver request trip information may also be processed under the optimized driver allocation process, and vice versa.

Turning first to the specific driver allocation process, trips which include trip information indicating a specific driver or preferred driver request may be separated into pools of trips as shown in blocks 303 and 351. The pools of trips may be further separated based on the information associated with each trip itinerary. For example, the pools of trips may be further separated into sub-pools based on customer status, such as a VIP status 305, preferred customer status 307, or other customer status 309.

The sub-pools may then be processed by the specific driver allocation process, using the server computer 110, according to an order defined by the transportation service. For example, as shown in FIG. 3, trips which include a specific driver request may be processed before trips with preferred driver requests. Further, trips which include a specific driver request and include trip information indicating a VIP customer status 305 may be processed before trips including trip information indicating a preferred customer status 307 or other customer status 309. Trips which include a preferred driver request may be processed upon the allocation of all the trips which include a specific driver request. Stated another way, the specific driver allocation process may process initially all trips which include a specific driver request starting with those trips which have trip information including a VIP customer status 305, then process those trips which have a preferred customer status, and finally process the trips associated with other customer status 309. The specific driver allocation processing may then follow the same order for all trips which include a preferred driver request 350 in the trip information. In some embodiments, trip itineraries may include multiple preferred driver requests or specific driver request. In this scenario the trip may be processed consecutively starting with the most preferred driver or first ranked specific driver until all of the preferred driver and/or specific drivers have been attempted to be allocated to the trip.

Each sub-pool may be further divided into hourly and non-hourly trip types, as shown in block 315. In this regard, for each trip in a sub-pool which is being processed, a determination may be made whether the trip is an hourly (i.e., no set start and stop points) or non-hourly (i.e., set start and stop points) trip. Such information may be determined from the trip itinerary information, such as found in Table 1. The sub-pools of trips may then be passed onto the specific driver allocation algorithm as shown in block 321.

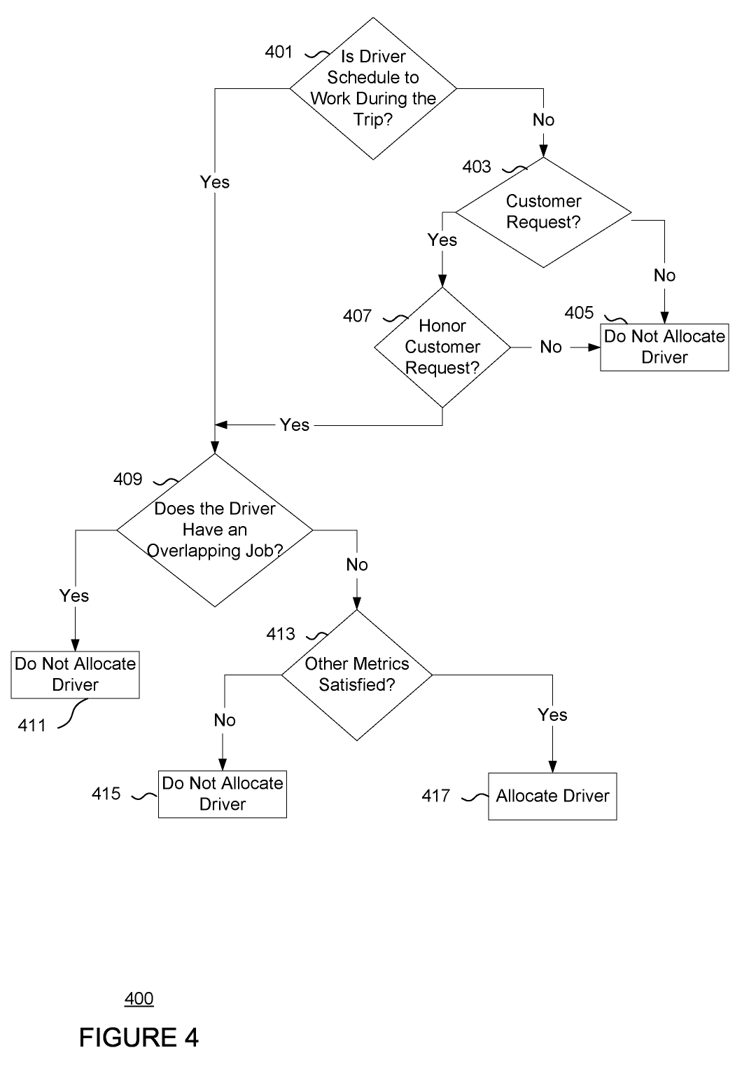

The hourly and non-hourly trips of the sub-pools may be processed using a specific driver allocation algorithm 400 as shown in FIG. 4. In this regard, the specific driver allocation algorithm may then process all hourly trips 317 from the sub-pool and then process all non-hourly trips 319 from the sub-pool with a specific driver allocation algorithm. As hourly trips tend to be more profitable than non-hourly trips, hourly trips may be processed first, though the transportation company may select a different order. Further, the specific driver allocation algorithm may process each trip starting with the trip with the earliest pick-up time first, and then process the subsequent trips in order, with the trip with the latest pick-up time being processed last.

For each trip, starting with the earliest pick-up time first, as described above, the specific driver allocation algorithm may allocate a specific driver to the trip. In this regard, the driver information associated with the requested driver may be analyzed to determine if the requested driver is scheduled to work during the trip, as shown in block 401.

Should the driver not be scheduled to work, the specific driver allocation algorithm may determine whether the specific driver request is based on a customer request, as shown in block 403. Should the request for a specific driver not be based on a customer request, no driver may be allocated to the trip in block 405 and the next trip from the sub-pool of trips may be processed. In the event the specific driver request is a customer request the process may move to block 407 to determine whether the transportation company will honor the off market request. Such a determination may be based on the requested driver's willingness to work during the trip period, the number of hours the driver has worked that week/day, and other such factors. Should the request for a specific driver not be denied, no driver may be allocated to the trip in block 405 and the next trip from the sub-pool of trips may be processed. Should the request for a specific driver be honored, or if the driver is scheduled to work, as determined at block 401, the process may move to block 409.

As shown in block 409, a determination may be made whether the requested driver has an overlapping job at the time of the trip currently being processed. Should the driver have an overlapping job, no driver may be allocated to the trip in block 411 and the next trip from the sub-pool of trips may be processed. Should the driver not have an overlapping job, the process may move to block 413, as further shown in FIG. 4.

As shown in block 413, a determination may be made whether other metrics are satisfied which will enable the requested driver to be allocated to the trip. In this regard, other metrics may include determining whether the driver has indicated a desire to be ignored at the time of the job, the requested driver has indicated they do not wish to serve the customer associated with the trip, the driver has an invalid vehicle for the trip (e.g., driver has a car but a van is needed) the driver does not have a valid license for the job (e.g., driver has a TLC license but needs a CLC license for the trip) the driver is too inexperienced for the customer associated with the trip (e.g., customer is a very valuable customer and the driver does not have enough experience to serve such a level of clientele), etc. Such information may be determined from the driver information, such as that found in Table 2. In addition, the metrics may also include whether the requested driver may make the trip and his next trip in time, should he be assigned the trip. Should all of the metrics be met, the requested driver may be allocated to the trip in block 417. Otherwise, no driver may be allocated to the trip in block 415 and the next trip from the sub-pool of trips may be processed.

Upon completion of the sub-pool of trips, the specific driver allocation algorithm may then process all non-hourly trips 319 from the sub-pool in a similar fashion, until all of the trips have been processed. In the event that a trip was not able to be allocated the trip may be passed to the next sub-pool. For example, should a trip from the specific driver request sub-pool not be allocated, the trip may be passed to the preferred driver request sub-pool if the trip itinerary includes a preferred driver request. Otherwise the trip may be passed to the start driver day 311 or end driver day 313 sub-pools, or to the optimized driver allocation process as shown in block 302, of FIG. 3 described in further detail herein.

Upon completion of the specific driver request pool 303 and preferred driver request pool 351, the specific driver allocation process may attempt to allocate drivers based on the start driver day 311 and end driver day 313 pools. The start driver day and end driver day pools may be configured to provide drivers with convenient trips at the start and finish of their work days, respectively. Depending on the transportation company's preferences, the start driver day pool 311 may be processed first or the end driver day pool 313 may be processed first. For purposes of illustration, the following example will process the start driver day pool 311 first. In this regard, the drivers may be allocated into start driver day pools based on the drivers' work day start time. For each driver in the pool, a trip may be allocated to the driver which occurs near the driver's starting location (e.g., home location or garage location) and starting time. Similarly, drivers may be allocated into end driver day pools based on the drivers' ending location (e.g., home location or garage location) and ending time. For each driver in the pool, a trip may be allocated to the driver which ends near the driver's ending location around the time the driver's day will end.

All trips which were not allocated by the specific driver allocation process may be passed to the optimized driver allocation process.

Upon completing the specific driver allocation process 301 the server computer 110 may perform the optimized driver allocation process 302 on all remaining trips, as shown in FIG. 3. In this regard, all remaining trips within an immediate time window 331, such as within two hours of the current time, or more or less, may be placed into a pool of trips. All subsequent trips may be placed into subsequent pools of trips 333 based on the pick-up time associated with that trip. For example, trips may be placed into subsequent pools of trips corresponding to two hour pick-up time windows. In one example, if the current time is noon, all trips which trip information indicating a pick-up time between noon and 2:00 PM may be placed within the immediate time window. Trips between 2:00 PM and 4:00 PM may be placed in a subsequent time window 333, while trips between 4:00 PM and 6:00 PM may be placed into another subsequent time window 333, etc. The time windows may be rolling, meaning if the optimized driver allocation process 302 runs at 3:15 PM, the two hour immediate time window 331 and subsequent time windows 333 may be determined from the run time of 3:15 PM.

The optimized driver allocation process 302 may process each pool based on time priority (e.g., the pool with the most current time window to the pool with the least current time pool). For each pool, starting with the immediate time window pool 331, sub-pools may be determined based on trip itinerary information associated with the trips in the time window, as shown in block 335. For example, the trip itinerary, such as the trip itinerary information as shown in Table 2 above, may be determined for each trip. Each trip in the time window may then be placed into sub-pools according to its associated trip itinerary information. In one example all, or some, trips which include trip itinerary information indicating the trip is hourly and has requested an upgraded vehicle with an experienced driver may be placed into a first sub-pool as shown by block 337. Trips which include trip itinerary information indicating the trip is hourly and has requested an upgraded vehicle but not an experienced driver may be placed into a second sub-pool as shown by block 339, and trips which include trip itinerary information indicating a non-hourly trip may be placed into a third sub-pool as shown in block 341. The sub-pools may then be processed by the optimized driver allocation algorithm as shown in block 343. The sub-pools may also be determined based on other itinerary information selectable by the transportation company.

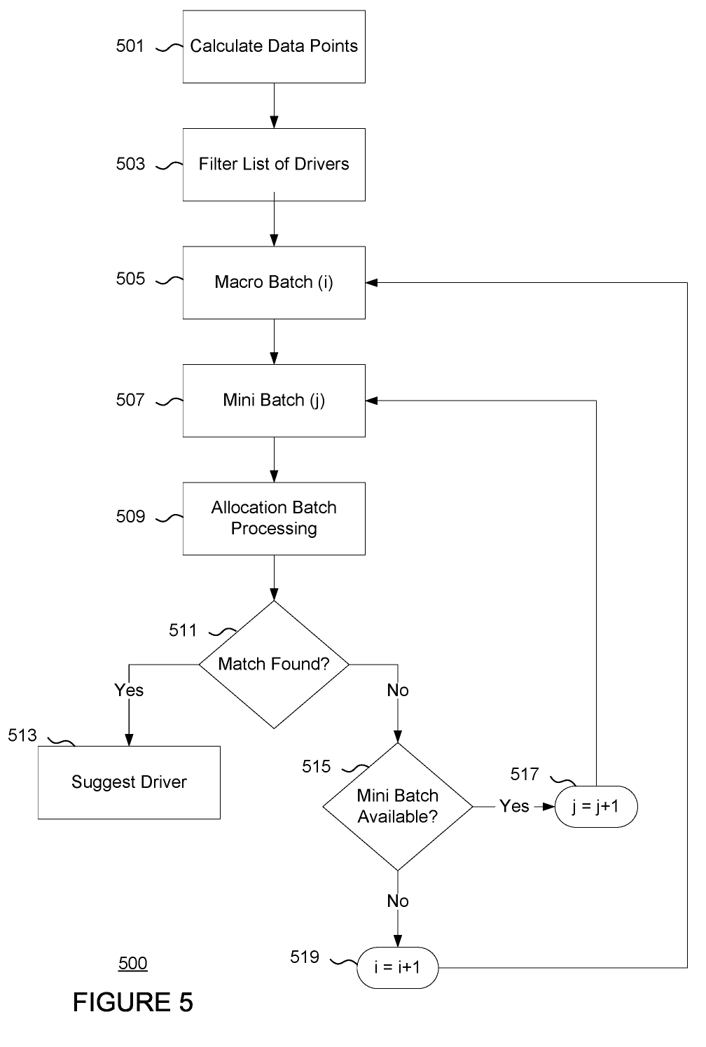

The sub-pools may be processed using an optimized driver allocation algorithm 500 as shown in FIG. 5. In this regard, the optimized driver allocation algorithm may process all trips from the first sub-pool and then process all subsequent sub-pools in order starting from the second sub-pool to the third sub-pool, etc., although other orders may be possible. Further, the optimized driver allocation algorithm may process each trip within each sub-pool starting with the trip with the earliest pick-up time first, and then process the subsequent trips of the sub-pool in order, with the trip with the latest pick-up time being processed last.

For each trip, starting with the earliest pick-up time first, as described above, the optimized driver allocation algorithm may attempt to reduce the list of drivers which may be allocated to the trip. In this regard, the optimized driver allocation algorithm 500 may calculate data points for each trip, as shown in block 501. Data points may include determining the predictive status of all drivers based on the trip pick-up time, as described below, estimating a shift length for all drivers should they get the trip, determining whether the vehicle requested is available to the driver at the time of the trip, calculating the gap time of the drivers (i.e., time between trips) determining if the driver is at the same location as the pick-up location of the trip at the pick-up time, and calculating the direct distance (i.e., “Crows flight” distance) to the pick-up location from the drivers' current locations. Based on these data points, the list of available drivers may be reduced by removing drivers which do not satisfy the data points.

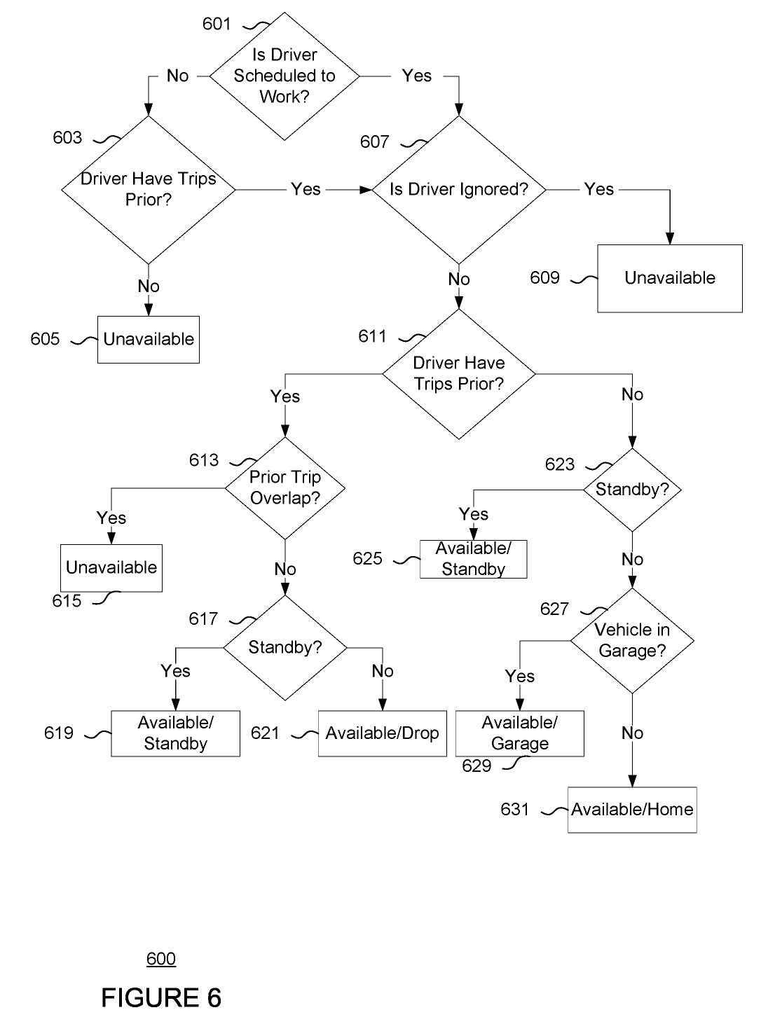

Turning first to the predictive status data point, the optimized driver allocation algorithm 500 may include a predictive status algorithm 600, as illustrated in FIG. 6. The predictive status algorithm 600 may be used to predict the availability and the location of a driver at the time of a pick-up, as well as the time the driver became available. For each trip, the predictive status algorithm may determine which drivers are scheduled to work at the time of the respective trip's pick-up time, as shown in block 601. The drivers' schedules may be found in the driver data, as shown in Table 2, above. Should a driver not be scheduled to work, the predictive status algorithm 600 may determine whether the driver had a trip prior to the trip's pick-up time, as shown in block 603. If the driver did not have a trip prior to the trip's pick-up time, the driver may be unavailable and be removed from the list of available drivers for the trip, as shown in block 605. Otherwise, should the driver have a trip prior to the trip's pick-up time, or if the driver is scheduled to work, the process may move to block 607.

At block 607 the predictive status algorithm 600 may determine whether the driver has requested to be ignored, or if the transportation company wishes the driver to be ignored. In this regard, the driver or transportation company may not wish to assign the driver to the trip due extraneous factors, such as the driver requests a break during the trip's pick-up time or the transportation company desires to allocate the driver to another trip. Thus, if a driver is ignored the driver may be unavailable and be removed from the list of available drivers for the trip, as shown in block 609. Otherwise, the process may move to block 611.

At block 611 the predictive status algorithm 600 may determine whether the driver has any trips prior to the trip being processed. Should the driver have any prior trips the predictive status algorithm 600 may proceed to block 613 to determine whether any of the prior trips overlap the trip being processed. In this regard, a determination may be made based on the prior trips pick-up time and estimated time of arrival (ETA), described in greater detail below, whether the prior trips would overlap the trip being processed. For example, the trip being processed may have a pick-up time of 1:45 pm, and the prior trip may have a pick-up time of 1:00 pm and an ETA of 2:00 pm. As such, the prior trip overlaps with the trip being processed. When the driver has a prior trip which overlaps the trip being processed the driver may be unavailable and be removed from the list of available drivers for the trip, as shown in block 615. Otherwise, the process may move to block 617.

At block 617 the predictive status algorithm 600 may determine whether the driver has an active or scheduled standby (i.e., a wait after the latest prior trip). Active standby may be unscheduled and the result of the driver not having another trip scheduled after a drop off. Scheduled standby may be the result of a driver being assigned standby duty at a certain location, such as a train station, airport, or other high volume area. In the event a driver is in standby the driver may be available at a standby location with a corresponding time of availability as the time the driver went into standby, as shown in block 619. Otherwise, if the driver is in standby the driver may be available at the location of the drop-off location of the latest prior trip with a corresponding time of availability as the time ETA of the latest prior trip.

Referring back to block 611, should the driver not have prior trips the predictive status algorithm 600 may proceed to block 623 to determine whether the driver has an active or scheduled standby prior to the pick-up time of the trip being processed. In the event the driver is in standby the driver may be available at a standby location with a corresponding time of availability as the time the driver went into standby, as shown in block 625.

As shown in block 627, if the driver is in not in standby the predictive status algorithm 600 may determine whether the driver's vehicle is in the transportation company's garage. Should the vehicle be in the garage of the transportation company, the driver may be available at the location of the garage with a corresponding time of availability as the time the driver is scheduled to start their shift, as shown in block 629. Should the vehicle not be in the garage of the transportation company, the driver may be available at the location of the driver's home, as found within the driver data of Table 2, with a corresponding time of availability as the time the driver is scheduled to start their shift, as shown in block 629.

The estimated shift length data point for all drivers, should they get the trip, may also be determined. In this regard for each driver, estimated travel duration, as determined by the estimated travel duration algorithm described in detail below, may be added to the current shift length of the driver. The resulting total time may be the estimate shift length.

A gap time data point may also be calculated for each driver by the optimized driver allocation algorithm 500. In this regard, for each driver, the difference between the pick-up time of the trip currently being processed and the time the driver is available, as found by the predictive status algorithm may be calculated. The time difference may be the gap time.

A data point indicating whether the vehicle requested for the trip being processed may also be calculated. In this regard a list of vehicles may be stored by the server computer of the transportation company, such as server computer 110. The list of vehicles may be associated with drivers who are scheduled to operate the vehicles at specified times. The optimized driver allocation algorithm 500 may determine whether the requested vehicle is available for the trip by determining whether the requested vehicle is scheduled for a trip at the time of the requested trip.

Data points indicating whether the drivers are at the same location as the pick-up location of the trip at the pick-up time, and calculating the direct distance (i.e., “Crows flight” distance) to the pick-up location from the drivers' current location may be based on the results of the predictive status algorithm 600. In this regard the direct distance to the pick-up location from the drivers' current location may be calculated by use the drivers location as determined by the predictive status algorithm, or from a location signal indicating a latitude and longitude received from the driver computing devices 130 of the drivers, and calculating the direct distance to the pick-up location of the trip being processed.

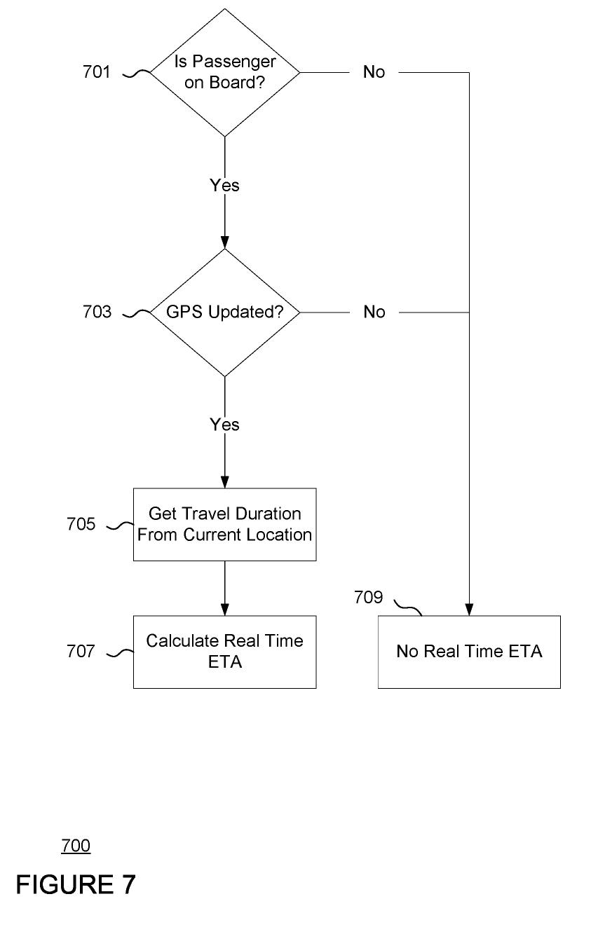

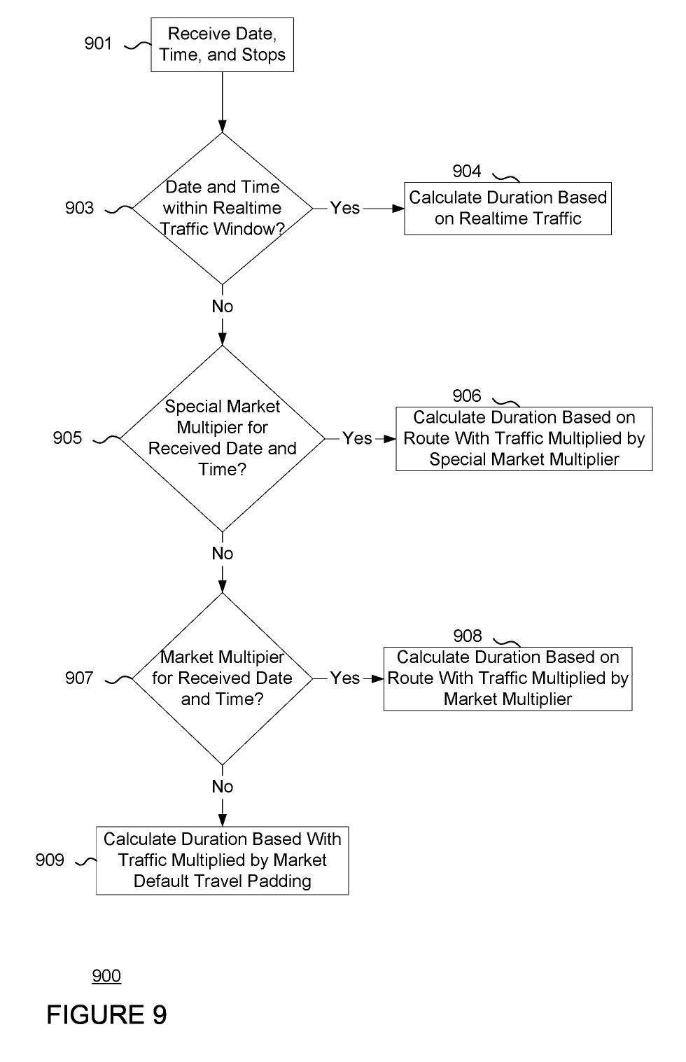

An estimated time of arrival (ETA) may be used to determine whether prior trips overlap. In this regard, an ETA may be in real time or predictive. FIG. 7 illustrates a process 700 for determining a real time ETA of a trip. For each trip a determination is made on whether the passenger is on board, as shown in block 701. If the passenger is not on board no real time ETA is available, as shown in block 709. If a passenger is on board, the driver computing device 130 may be queried for a GPS update of the location of the driver on the trip, as shown in block 703. If no GPS update is provided, no real time ETA is available, as shown in block 709. Otherwise, the travel duration may be determined based on the GPS location which was provided, as shown in 705. In this regard, the travel duration may be determined using the estimated travel duration, as shown in FIG. 9, explained in detail below. Based on the travel duration a real time ETA may be calculated by adding the travel duration with the current time, as shown in block 707.

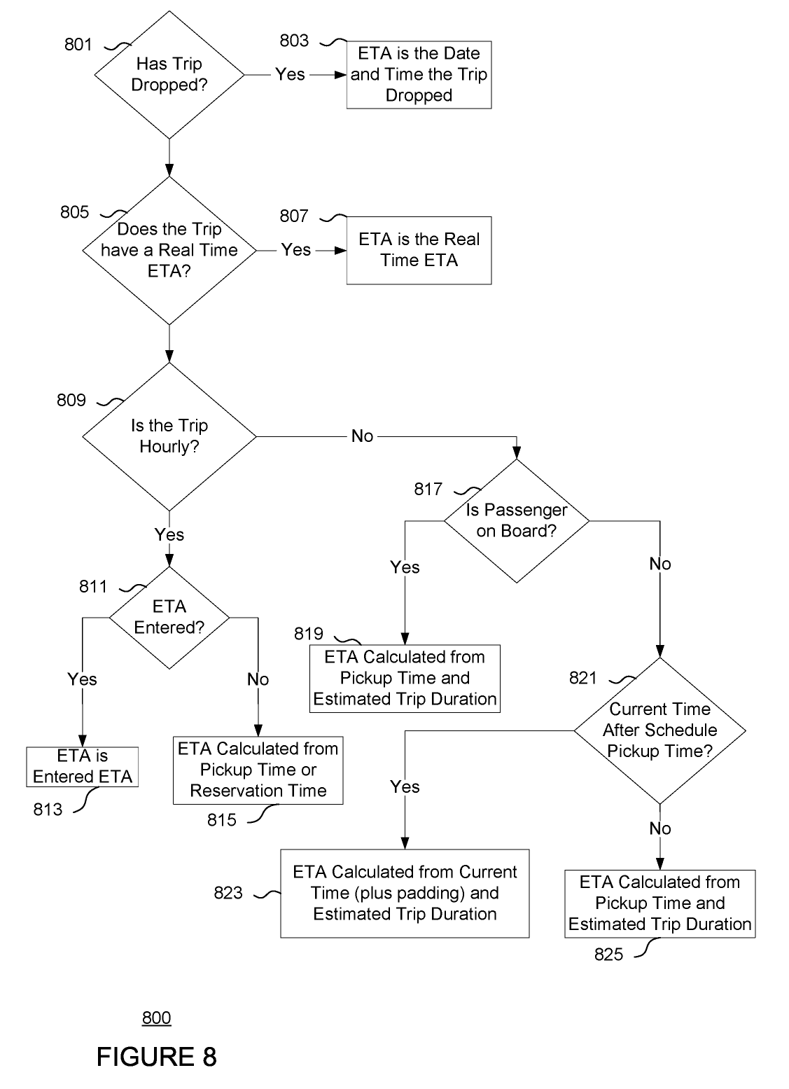

Turning now to FIG. 8, a predictive ETA may be determined for all trips using a predictive ETA algorithm 800. In this regard, for each trip, a determination may be made whether the trip has been dropped as shown by block 801. If the trip has been dropped, the predictive ETA may be the time the trip dropped (i.e., completed), as shown by block 803. In the event the trip did not drop a determination may be made whether the trip has a real time ETA, as shown in block 805. The real time ETA may be the predictive ETA, as shown in block 807.

The process may move to block 809 should the trip not have a real time ETA and the trip has not dropped. At block 809 a determination may be made whether the trip is an hourly or non-hourly trip. For hourly trips the computer server 110 may determine whether the driver of the trip, or other individual such as the dispatcher 220, has entered an ETA. If so the entered ETA is predictive ETA as shown in block 813. Otherwise the predictive ETA may be assigned a time of the pick-up time or reservation time, such as four hours, or more or less, from the pick-up time or reservation time, as shown in block 815.

Returning to block 809, should the trip not be hourly, a determination whether a passenger is on board or not may be made, as shown in block 817. When a passenger is on board the predictive ETA may be calculated as the time the passenger was picked up plus the estimated travel duration as described below with regard to FIG. 9.

When no passenger is on board a determination of whether the trip pick-up time is after or before the current time may be made, as shown in block 821. When the pick-up time is after the current time, the predictive ETA may be calculated from the pick-up time plus a padding time, such as five minutes, or more or less, plus the estimated travel duration, as shown in block 823. When the pick-up time is after the current time, the predictive ETA may be calculated by adding the estimated trip duration to the pick-up time, as shown in block 825.

Based on the list of available drivers after processing the trip through the predicative status algorithm 600 and the data points the optimized driver allocation algorithm 500 may filter down the list of available drivers, as shown in block 503. In this regard, drivers who fail to satisfy set requirements may be filtered (e.g., removed) from the list of available drivers. The requirements may be determined by the transportation company and may be based on any trip itinerary information, driver information, or other information.

For example, drivers which are estimated to have a shift length of greater than 16 hours may be removed. Further, drivers who will not arrive on time based on their corresponding time of availability and determined direct distance may be removed from the list of available drivers. In this regard, the total miles in the determined direct distance may be multiplied by 45 seconds, or more or less, to determine a time to pick-up location. This time to pick-up location may be added to the driver's corresponding time of availability to estimate the time by which the driver will be able to reach the pick-up location of the trip being processed. In the event the time at which the driver will reach the pick-up location of the trip being processed is after the requested pick-up time, the driver may be removed from the list of available drivers.

Drivers who have an invalid car type, are on a do not send list of drivers which is associated with the customer requesting the trip, have an invalid license type, or who are not ranked high enough (e.g., too inexperienced, still in training, etc.,) may also be removed from the list of available drivers.

The remaining drivers on the list of available drivers may then be organized into macro batches as shown in block 505. In this regard, the list of available drivers may be placed into macro batches corresponding to criteria created by the transportation company. The macro batches may be tested and reorganized based on business metrics, such as increasing revenue, maximizing the number of trips which can be covered, avoiding the need to contract work, etc. An example set of macro batches is shown below in Table 3.

TABLE 3
Macro Batches

1. Under 10 hours shift, less than 15 miles - no vehicle upgrades (i.e., only
car which is requited by the customer)
2. No shift limit, less than 15 miles - no vehicle upgrades
3. 10 hour shift limit, allow vehicle upgrades - cap 30 miles for shift limit,
then open more inventory
4. All Drivers under 180 minutes gap
5. All Drivers from list of available drivers

As shown in Table 3, the drivers in the list of available drivers may be placed into macro batches based on shift length, distance to the pick-location of the trip being processed, vehicle type, etc. In this regard, drivers may be placed into more than one macro batch. In some embodiments, macro batches may have no drivers and may be skipped in the processing.

The optimized driver allocation process 302 may process the macro batches in order, starting from macro batch i=1 until a driver is found for the trip. In this regard, each macro batch may be passed to mini batch processing, as shown in block 507 of FIG. 5. Mini batches, like micro batches may be tested and reorganized based on business metrics and desired driver allocation outcomes, as determined by the transportation system. An example set of mini batches is shown in Table 4, below.

TABLE 4
Mini Batches

1. At same location and <= 60 minutes of gap - has dropped a trip, is not
in process on a trip
2. At same location and <= 90 minutes off gap - has dropped a trip, is not
in process on a trip
3. <= 5 miles away and <= 60 minutes of gap - has dropped a trip, is not
in process on a trip
4. <= 5 mile s away and <= 90 minutes of gap - has dropped a trip, is not
in process on a trip
5. <= 5 mile s away and <= 120 minutes of gap - has dropped a trip, is not
in process on a trip
6. At same location and <= 60 minutes of gap - has had a trip, and
estimated shift <= 10 hour s
7. At some location and <= 90 minutes of gap - has had a trip, and
estimated shift <= 10 hours
8. <= 5 miles away and <= 60 minutes of gap - has had a trip, and
estimated shift <= 10 hours
9. <− 5 miles away and <= 120 minutes of gap - has had a trip, and
estimated shift <= 10 hours
10. At some location and <= 60 minutes of gap
11. At some location and <= 90 minute s of gap
12. <= 5 miles away and <= 60 minute s of gap
13. <= 8 miles away and <= 60 minutes of gap
14. <= 5 miles away and <= 120 minute s of gap
15. <= 10 miles away and <= 60 minutes of gap
16. <= 10 miles away and <= 120 minutes of gap

As shown in Table 4, the drivers in the macro batch being processed may be assigned to micro batches based one or more of the location of the driver, the gap time of the driver, whether the driver has had a drop, the estimated shift length of the driver, etc. Each micro batch, starting with micro batch j=1 may be sent to allocation batch processing to determine whether a driver may be allocated to the trip currently being processed.

Allocation batch processing may include, for each driver in a mini batch, determining the driving travel distance and travel duration for the trip being processed, filtering drivers on standby less than a predetermined time period and located outside of a set radius of the trip, and selecting the driver with the shortest travel duration who can make his next trip if they are allocated the trip currently being processed.

In this regard, an estimated travel duration algorithm 900, as shown in FIG. 9 may be performed to determine the travel duration for each driver in the mini batch. Initially, the date, time and location of the stops for the trip being processed may be received by the computer running the allocation batch processing, such as server computer 110, as shown in block 901. Based on the date, time, and location of the stops, a determination of whether the date and time are within a real time traffic window, as shown in block 903. The real time traffic window may be within four hours of the current time and date, or more or less. If the trip being processed is within the real time traffic window the travel duration of the drivers may be based on real time traffic data, as shown in block 904. Real time traffic data may be received from a third party source, such as Google, Microsoft, or Yahoo and estimated travel duration may be calculated based on the estimates provided by the third party source.

Should the trip being processed not be within the real time traffic window, a determination may be made to determine if a special market multiplier is applicable at the date, time, and/or location of the trip, as shown in block 905. A special market multiplier may be used to account for delays due to circumstances occurring on the route the driver must take to reach the pick-up location of the trip. For example, a special market multiplier of 1.25 may be applied to an estimated duration when the driver's route takes him past a construction site. Special market multipliers may be determined by the transportation company based on past operating history or traffic updates, and may be stored in a storage device, such as storage device 150. As such, the estimated duration may be the estimated travel duration based on the time required to transverse the route multiplied by the special market multiplier, as shown in block 906.

When no special market multiplier is applicable a determination may be made whether a general market multiplier is applicable, as shown in block 907. For example, a general market multiplier of 1.1 may be applied to an estimated duration when the driver's route takes him past a school while school is being let out. Like special market multipliers, general market multipliers may be determined by the transportation company based on past operating history or traffic updates, and may be stored in a storage device, such as storage device 150. As such, the estimated duration may be the estimated travel duration based on the time required to transverse the route multiplied by the general market multiplier, as shown in block 908. Otherwise the estimated travel duration may be based on the time required to transverse the route without any multipliers as shown in block 909.

Upon determining the estimated travel duration for each trip in the micro batch, all drivers who were on standby less than a predetermined time period, such as one hour, or more or less, and who are outside of a predetermined radius from the pick-up location, such as two miles, or more or less, may be removed from the micro-batch.

For each remaining driver in the micro batch, if there are any, a match to the trip being processed may be determined, as shown in block 511. In this regard for each remaining driver a determination may be made if the driver was allocated the trip, would they make their next scheduled trip. All drivers who will not make their next allocated trip, or who do not have an allocated trip may be removed. The driver with the shortest travel duration may then be matched, and allocated to the trip currently being processed, as shown in block 513.

Should no match be made between the drivers in the mini batch and the trip, a determination if mini batches associated with the current macro batch are available may be made, as shown in block 515. If so, the next mini batch, j=j+1, as shown in block 517, may be analyzed with the allocation batch processing, as described above. If no more mini batches are available, the next macro batch, i=i+1, as shown in block 519, may be processed. Should no macro or micro batches remain the trip may not be allocated and the next pool of trips may be processed, as described above.

Upon determining a specific or optimized driver for a trip, the driver may be automatically allocated to that trip by the server computer 110 or dispatcher computer 120. Alternatively, the dispatcher 220 may be informed of the allocations and may manually approve some or all of the allocations through dispatcher computer 120.

Most of the foregoing alternative examples are not mutually exclusive, but may be implemented in various combinations to achieve unique advantages. As these and other variations and combinations of the features discussed above can be utilized without departing from the subject matter defined by the claims, the foregoing description of the embodiments should be taken by way of illustration rather than by way of limitation of the subject matter defined by the claims. As an example, the preceding operations do not have to be performed in the precise order described above. Rather, various steps can be handled in a different order, such as reversed, or simultaneously. Steps can also be omitted unless otherwise stated. In addition, the provision of the examples described herein, as well as clauses phrased as “such as,” “including” and the like, should not be interpreted as limiting the subject matter of the claims to the specific examples; rather, the examples are intended to illustrate only one of many possible embodiments. Further, the same reference numbers in different drawings can identify the same or similar elements.

1. A computer implemented method for determining a driver for a trip having a start time within a predetermined time period, the method comprising:
receiving, by one or more processors, a trip itinerary for a first client's trip;
receiving, by the one or more processors, a list of available drivers, wherein each available driver on the list of available drivers includes a respective driver status indicating each trip scheduled for the driver for the predetermined time period;
removing, by the one or more processors, based on the respective driver status of each available driver, one or more drivers from the list of available drivers to obtain a reduced list of available drivers; and
selecting, with the one or more processors, based on the reduced list of available drivers and the trip itinerary for the first client's trip, a driver from the reduced list of available drivers.

2. The method of claim 1, wherein the trip itinerary includes a pick-up location, a drop off location, and a time for the trip.

3. The method of claim 1, wherein each respective driver status includes at least one of estimated shift length, predicted driver status, minimum travel duration for a scheduled trip, vehicle type, client approval, license type, or ranking.

4. The method of claim 1, wherein removing one or more drivers from the list of available drivers further includes:
removing, by the one or more processors, a given driver whose driver status includes at least one of:
an estimated shift length greater than a predetermined threshold; or
a predicted driver status indicated as unavailable.

5. The method of claim 1, wherein the trip itinerary further includes a client preferred vehicle type and a client excluded driver name, and
removing one or more drivers from the list of available drivers further includes:
removing, by the one or more processors, a given driver whose driver status includes at least one of:
a minimum travel duration greater than a predetermined threshold;
a vehicle type other than the client preferred vehicle type; or
a name matching the client excluded driver name.

6. The method of claim 1,
wherein removing one or more drivers from the list of available drivers includes determining at least one of:
an expected travel distance for a given driver to a pick-up location for the trip;
an expected travel duration for the trip;
an expected time gap between the trip and a second trip scheduled for the given driver immediately before or after the trip; or
an estimated shift length of the given driver.

7. The method of claim 6, wherein the expected travel duration is determined using a multiplier obtained from expected traffic data.

8. The method of claim 7, wherein the expected travel duration is determined using real time traffic data.

9. A system for determining a driver for a trip having a start time within a predetermined time period, the system comprising:
one or more computing devices; and
memory storing instructions, the instructions executable by the one or more computing devices;
wherein the instructions comprise:
receiving a trip itinerary for a first client's trip;
receiving a list of available drivers, wherein each available driver on the list of available drivers includes a respective driver status indicating each trip scheduled for the driver for the predetermined time period;
removing, based on the respective driver status of each available driver, one or more drivers from the list of available drivers to obtain a reduced list of available drivers; and
selecting, based on the reduced list of available drivers and the trip itinerary for the first client's trip, a driver from the reduced list of available drivers.

10. The system of claim 9, wherein the trip itinerary includes a pick-up location, a drop off location, and a time for the trip.

11. The system of claim 9, wherein each respective driver status includes at least one of estimated shift length, predicted driver status, minimum travel duration for a scheduled trip, vehicle type, client approval, license type, or ranking.

12. The system of claim 9, wherein removing one or more drivers from the list of available drivers further includes:
removing, by the one or more processors, a given driver whose driver status includes at least one of:
an estimated shift length greater than a predetermined threshold; or
a predicted driver status indicated as unavailable.

13. The system of claim 9, wherein the trip itinerary further includes a client preferred vehicle type and a client excluded driver name, and removing one or more drivers from the list of available drivers further includes:
removing a given driver whose driver status includes at least one of:
a minimum travel duration greater than a predetermined threshold;
a vehicle type other than the client preferred vehicle type; or
a name matching the client excluded driver name.

14. The system of claim 9,
wherein removing one or more drivers from the list of available drivers includes determining at least one of:
an expected travel distance for a given driver to a pick-up location for the trip;
an expected travel duration for the trip;
an expected time gap between the trip and a second trip scheduled for the given driver immediately before or after the trip; or
an estimated shift length of the given driver.

15. The system of claim 14, wherein the expected travel duration is determined using a multiplier obtained from expected traffic data.

16. The system of claim 15, wherein the expected travel duration is determined using real time traffic data

17. A non-transitory computer-readable medium storing instructions that, when executed by one or more processors, cause the one or more processors to perform the steps of:
receiving a trip itinerary for a first client's trip including a start time within a predetermined time period;
receiving a list of available drivers, wherein each available driver on the list of available drivers includes a respective driver status indicating each trip scheduled for the driver for the predetermined time period;
removing, based on the respective driver status of each available driver, one or more drivers from the list of available drivers to obtain a reduced list of available drivers; and
selecting, based on the reduced list of available drivers and the trip itinerary for the first client's trip, a driver from the reduced list of available drivers.

18. The non-transitory computer-readable medium of claim 17, wherein each respective driver status includes at least one of estimated shift length, predicted driver status, minimum travel duration for a scheduled trip, vehicle type, client approval, license type, or ranking.

19. The non-transitory computer-readable medium of claim 17,
wherein removing one or more drivers from the list of available drivers includes determining at least one of:
an expected travel distance for a given driver to a pick-up location for the trip;
an expected travel duration for the trip;
an expected time gap between the trip and a second trip scheduled for the given driver immediately before or after the trip; or
an estimated shift length of the given driver.

20. The non-transitory computer-readable medium of claim 19, wherein the expected travel duration is determined using a multiplier obtained from expected traffic data or real time traffic data.
